(19) United States
(12) Patent Application Publication
(10) Pub. No.: US 2017/0346921 A1
(43) Pub. Date: Nov. 30, 2017

(54) METHOD FOR LANGUAGE-INDEPENDENT GENDER CLASSIFICATION ON TWITTER

(71) Applicant: Umm-Al-Qura University, Makkah (SA)

(72) Inventors: Sohaib Ghani, MAKKAH (SA); Jalal Alowibdi, MAKKAH (SA)

(73) Assignee: Umm-Al-Qura University, MAKKAH (SA)

(21) Appl. No.: 15/169,463

(22) Filed: May 31, 2016

(51) Int. Cl. H04L 29/08; G06F 17/30; H04L 12/58

(52) U.S. Cl. CPC H04L 67/306; H04L 51/32; G06F 17/30598; G06F 17/30864

(57) ABSTRACT

Online Social Networks (OSNs) allow users to share knowledge, opinions, interests, activities, relationships and friendships with each other. Gender classification of users of an OSN such as Twitter may be difficult to ascertain because gender is not necessarily provided. The present invention relates to a computer-implemented method for predicting gender classification of users of an OSN such as Twitter. The computer-implemented method may predict gender using five color-based features extracted from Twitter profiles such as the background color in a user's profile page. This is in contrast with most existing methods for gender prediction that are language dependent. Those methods use high-dimensional spaces consisting of unique words extracted from such text fields as postings, user names, and profile descriptions. The present method is independent of the user's language, efficient, scalable, and computationally tractable, while attaining a good level of accuracy.

### FIELD OF TECHNOLOGY

The disclosure generally relates to a method and system for language-independent gender classification on an Online Social Network such as Twitter.

### BACKGROUND

Online Social Networks (OSNs) have spread at stunning speed over the past decade. They are now a part of the lives of dozens of millions of people. The onset of OSNs has stretched the traditional notion of “community” to include groups of people who have never met in person but communicate with each other through OSNs to share knowledge, opinions, interests and activities.

Online Social Networks (OSNs) generate a huge volume of user-originated texts. OSNs allow users to share knowledge, opinions, interests, activities, relationships and friendships with each other. Gender classification can serve multiple purposes in these settings. Commercial organizations may use gender classification for advertising. Law enforcement may use gender classification as part of legal investigations. Others may use gender information for social reasons.

Methods for gender classification of users of OSNs are typically language dependent, not scalable, inefficient, and held offline using high-dimensional spaces. For example, most existing approaches to gender classification on Twitter depend heavily on an analysis of text in posted messages, aptly called tweets. Most existing research for gender classification on Twitter is language dependent. Those methods use high-dimensional spaces consisting of unique words extracted from such text fields as postings, user names, and profile descriptions. Those existing approaches use word based n-grams resulting in a huge feature space consisting of unique words and word combinations extracted from tweets. The size of the resulting feature sets is often in the order of many million features.

There is a need in the field for gender identification of users of OSNs with an emphasis on accuracy, computational efficiency and scalability of gender predictions. There is especially a need in the field for language-independent methods for determining gender information of users of OSNs.

### SUMMARY

In an embodiment, there is provided a computer-implemented method for predicting gender classification of users of an OSN such as Twitter. In an embodiment, the computer-implemented method may predict gender using five color-based features extracted from Twitter profiles such as the background color in a user's profile page. This is in contrast with most existing methods for gender prediction that are language dependent. Those methods use high-dimensional spaces consisting of unique words extracted from such text fields as postings, user names, and profile descriptions. The present method is independent of the user's language, efficient, scalable, and computationally tractable, while attaining a good level of accuracy.

In an embodiment, there is provided a computer-implemented method comprising: receiving a color data set of a given user of an online social network, said online social network allowing said given user to select a set of colors within its profile; and comparing said color data set of said given user to predetermined color data sets for determining a gender of said given user.

In another embodiment, there is provided a computer-implemented method comprising: receiving color data sets of a plurality of users of an online social network, said online social network allowing each user to select a set of colors within their profile; quantizing said color data sets into predetermined color data sets; assigning a gender to each predetermined color data sets; receiving a color data set of a given user of said online social network; and comparing said color data set of said given user to said predetermined color data sets for determining a gender of said given user.

In another embodiment, there is provided a system comprising: a memory; and one or more processors coupled to the memory, wherein the memory comprises program instructions to: receive color data sets of a plurality of users of an online social network, said online social network allowing each user to select a set of colors within their profile; quantize said color data sets into predetermined color data sets; assign a gender to each predetermined color data sets; receive a color data set of a given user of said online social network; and compare said color data set of said given user to said predetermined color data sets for determining a gender of said given user.

### BRIEF DESCRIPTION OF THE DRAWINGS

FIG. 1 shows a flow chart of an embodiment of a computer-implemented method for demining a gender of a given user of an online network such as Twitter.

FIG. 2 shows a block diagram of a system for demining a gender of a given user of an online network such as Twitter.

FIG. 3 shows a block diagram of four subsets in an experimental dataset.

FIG. 4 shows an algorithm for preprocessing colors to a classifier.

FIG. 5 shows a color distribution of profile background colors harvested from profiles in the experimental data set before quantization.

FIG. 6 shows the 512 colors obtained from the quantization color procedure of 9-bit RGB after quantization and sorting.

FIG. 7(a) shows the centroid of a quantization color procedure.

FIG. 7(b) shows the color distribution of both genders for the profile background after applying the quantization color procedure to the data set.

FIG. 7 (c) shows the color distribution of the profile background of female users after applying the quantization color procedure to the data set

FIG. 7(d) shows the color distribution of the profile background of male users after applying the quantization color procedure to the data set.

FIG. 8 shows the difference in colors chosen by female vs. male Twitter users.

### DETAILED DESCRIPTION

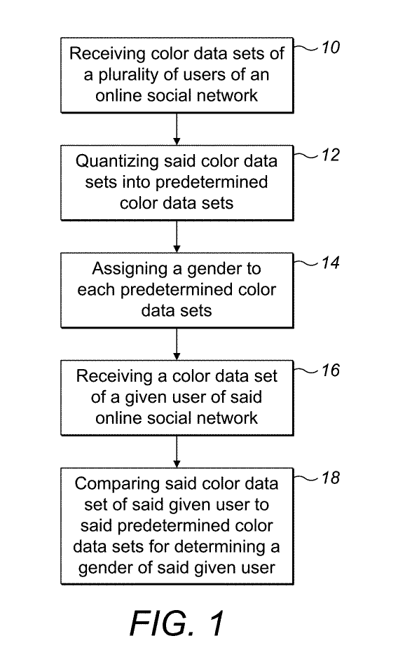

Referring to FIG. 1, there is shown an embodiment of a computer-implemented method for demining a gender of a given user of an online network such as Twitter. The computer-implement method may include a step 10 of receiving color data sets of a plurality of users of an online social network. The online social network allows each user to select a set of colors within their profile. The method the includes a step 12 of quantizing the color data sets into predetermined color data sets to reduce the number of color combinations. The method may include a step 14 of assigning a gender to each predetermined color data sets. This assignation may be based on an empirical analysis of color data of user's profile that maps onto a gender. The method may include a step 16 of receiving a color data set of a given user of the online social network and a step 18 of comparing the color data set of the given user to the predetermined color data sets so as to determine a gender of the given user.

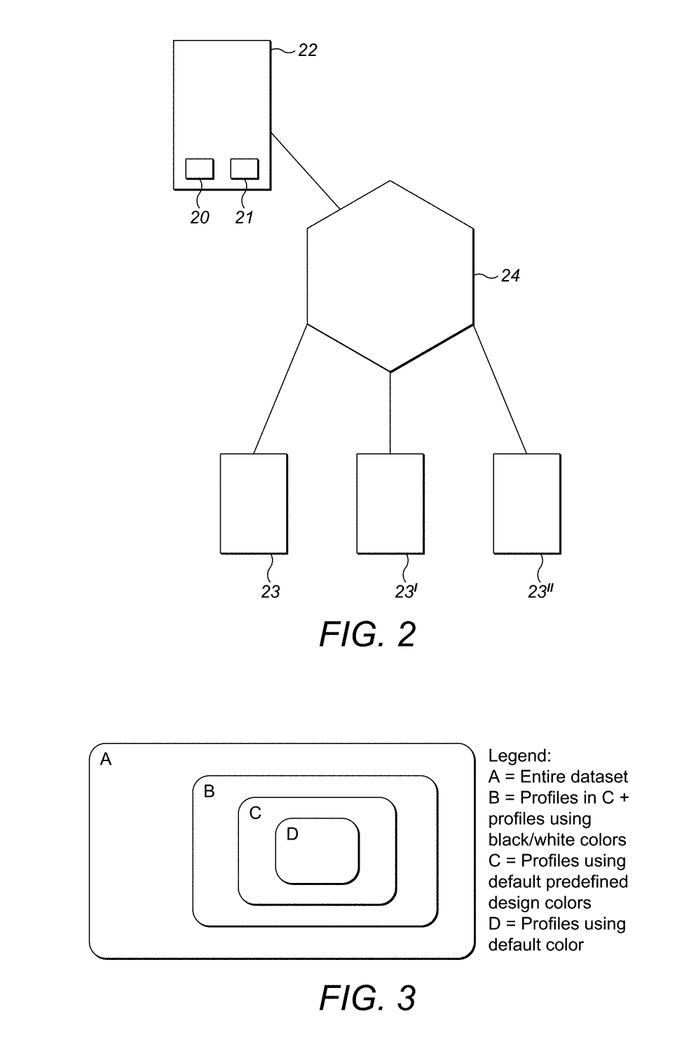

Referring to FIG. 2, there is shown an embodiment of a system for demining a gender of a given user of an online network such as Twitter. The system may include a memory 20 and one or more processors 22 coupled to the memory 20 stored in a computer 22. The computer 22 may be a stand-alone computer or any other similar device. The computer 22 may be replaced by a cloud-based application located in a server. The memory 20 may include program instructions to receive color data sets of a plurality of users 23, 23′, 23″ of an online social network 24. As described above, the online social network 24 allows each user to select a set of colors within their profile. The memory program instructions may then quantize the color data sets into predetermined color data sets so as to reduce the number of color combinations. The program instructions may then assign a gender to each predetermined color data sets. The program instructions may then receive a color data set of a given user 23 of the online social network 24 and compare the color data set of the given user to the predetermined color data sets for determining a gender of the given user.

Dataset Collection: Applicants chose Twitter profiles as the starting point of their data collection for several reasons. First, Twitter is one of the most popular social networks to date with a huge user community cutting across great many languages, cultures and age groups. In early 2013, Twitter reached 555 million registered users. As of today, Twitter states that there are more than 200 million active users producing around 400 million tweets per a day. Second, Twitter has all the color attributes that were needed to set up the experiment. These attributes are generally public, meaning that they can be accessed and viewed by anyone who requests them. Lastly, Twitter provides a rich Application Programming Interface (API), which supports automatic collection of large data sets.

For Applicant's experiments, they chose Twitter profiles as the starting point of their data collection. In Twitter's terminology, the followers of a given user U are users interested in reading U's tweets. These users will be notified when U posts a new tweet. Also, the friends of a user V are the users following V's tweets. In general, users can register themselves as followers of any other user; no permission is required unless the user protects his/her profile using Twitter's protection features. A new Twitter user must first fill a profile form, consisting of about 30 fields containing biographical and other personal information, such personal interests and hobbies. However, many fields in the form are optional, and indeed substantial portions of Twitter users leave many or all of those optional fields blank. In addition, Twitter's profile form does not include a specific “gender” field, which complicates gender identification for Twitter users. One can choose additional fields that are not mentioned above for gender classification such as posted tweets; however, Applicants decided to perform gender classification using only profile colors.

Among many other fields in a Twitter profile, Applicants were interested in the five fields that allow users to choose different colors for the following items: Background color; Text color; Link color; Sidebar fill color; and Sidebar border color.

Users choose their own preferences by selecting colors from a color wheel while editing their profiles. Unlike other OSNs, such as Facebook, Twitter allows users to redesign and change their profiles. In some cases, users chose both a background color and a background picture (from a picture file) for their profiles. In these cases, the background picture overrides the background color, which is not shown. However, Applicants' empirical setup takes into account the background color chosen by a user even if that color is overridden by that user.

Applicants ran their crawler between August and December 2013, subject to Twitter's limitation of less than 150 requests per hour. Applicants started their crawler with a set of random profiles and continuously added any profile that the crawler encountered (e.g., profiles of users whose names were mentioned in tweets harvested). Subsequently, Applicants filtered all the profiles with valid URLs. The URL is a profile field that lets a Twitter user create a link to a profile hosted by another OSN, such as Facebook. This field is important because profiles hosted by other OSNs often contain an explicit gender field, which Twitter profiles do not include.

In all, the dataset Applicants used at the time of their study consisted of 169,449 profiles, of which 94,251 were classified as male and 75,198 were classified as female. Applicants considered only profiles for which they obtained gender information independently of Twitter content (i.e., by following links to other profiles). For each profile in the dataset, Applicants collected the five profile colors listed above. Applicants also stratified the data by randomly sampling 150,000 profiles, of which about 75,000 are classified as male and about 75,000 are classified as female. In this manner, one obtains an even baseline containing 50% male and female profiles. Twitter offers 19 predefined designs, including a default design, to each new user joining the social network. Each design defines colors for all five fields. Users can select those designs easily. As of this writing, the color (R=192, G=222, B=237), a light shade of blue, is the default background color for any new Twitter user.

In order to account for the existence of predefined designs in the Twitter user setup, Applicants have considered different subsets of their overall dataset, and studied each subset independently of other subsets. In addition, Applicants stratified each subset by randomly sampling the profiles, from which they obtained even baselines containing 50% male and female profiles. Applicants specifically considered the following subsets: [T1.] This is the entire dataset, {A}, consisting of 150,000 profiles with a 50% male and 50% female breakdown. [T2.] This is dataset {A}-{D}, which is the subset containing all collected profiles, except for profiles using the default design with the RGB values of (192, 222, 237) as the background color, denoted by {D}. {D} represents 11.4% of dataset {A} while {T2} represents 88.6%. The base condition is a 50% male and 50% female breakdown. [T3.] This is dataset is {A}-{C}, which is the subset obtained by excluding {C}, the subset all profiles that use any of the 19 predefined designs including the default design, from {A}. {C} represents around 57% of {A} while {T3} represents 43%. The base condition is a 50% male and 50% female breakdown. Here Applicants report detailed empirical results about {T3}, since it includes only profiles with custom color choices, and summarize results for the other datasets. [T4.] This is dataset {A}-{B}, obtained by excluding from the entire dataset, {A}, all profiles, {B}, that use any of the 19 predefined designs as well as black or white as background color. {B} represents 71.8% of {A}, while {T4} represents 28.2%. The base condition is still a 50% male and 50% female breakdown.

Referring to FIG. 3, there is shown the four subsets that Applicants considered for their analyses. Overall, female users are more likely to choose their own layout colors, while male users are more likely to use the default design or one of the other predefined designs.

Dataset Collection Validation: The main threat to the validity of this research is Applicants' reliance on self-declared gender information entered by Twitter users on external web sites for validation of their predictions. Applicants believe that deceptive people sometimes do make mistakes by entering conflicting information in different OSNs. In this study, Applicants rely on gender information from external links posted by profile owners. Applicants use this gender information as their ground truth. Evidently, a complete evaluation of 169,449 Twitter users would be impractical. However, Applicants manually spot-checked about 10,000 of the profiles in their dataset that is about 7% of the dataset. In the cases that Applicants checked by hand, they are confident that the gender information they collected automatically was indeed correct over 90% of the time. In the majority of the remaining cases Applicants could not determine the accuracy of their ground truth.

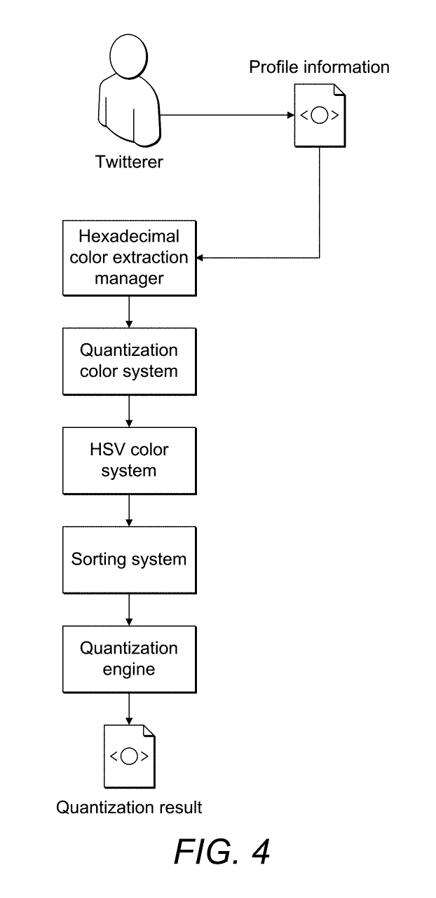

Proposed Approach: An algorithm for preprocessing colors before feeding the colors to a classifier is shown in FIG. 4. First, one harvest colors from user profiles. Next, one applies a color quantization and sorting procedure (i.e., normalization) to reduce the number of colors. The colors are converted from their Red, Green and Blue (RGB) representation to the corresponding HSV (Hue, Saturation, Value) representation. One then sorts the colors by their hue and value, and finally one converts them back to RGB. The sorting allows labeling similar colors (e.g., adjacent colors in the sort) by consecutive numbers that one feeds to the classifier.

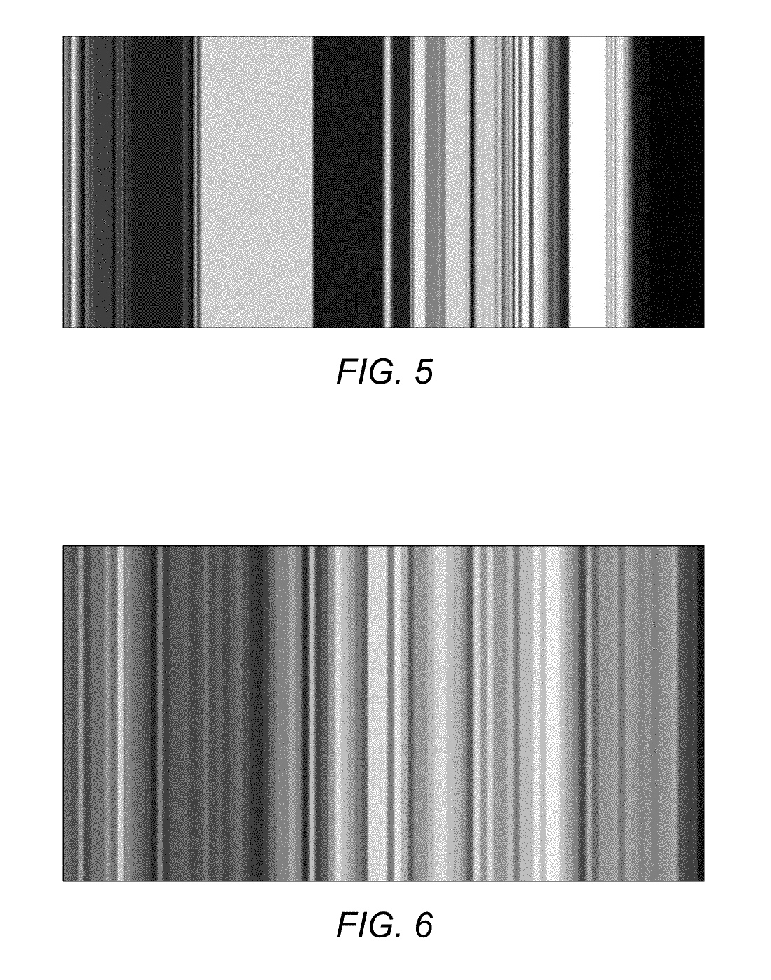

FIG. 5 shows the color distribution of profile background colors harvested from profiles in the experimental data set before quantization. Broader stripes denote the relative frequency of background color in the profiles that were analyzed. In particular, the broad light blue stripe to the center left of the figure represents the default background color of Twitter profiles.

Colors harvested from Twitter user profiles are typically specified as a combination of RGB values ranging between 0 and 255. This gives a total of 256³ colors combinations. Because of the large number of combinations, Applicants used quantization, a compression procedure that substantially reduces the huge number of colors. Each of the red, green and blue values is shrunk from 8 bits to 4 bits and 3 bits respectively. This technique reduces the total number of color combinations from 256³≈16*10⁶ to just 16³=4096 colors and 8³=512 colors, respectively. Each of the original colors harvested is converted to the compressed color having the least Euclidean distance from the original color. Next, according to the algorithm in FIG. 4, Applicants converted each quantized color to the corresponding HSV representation. Applicants used this representation for sorting the colors according to their similarity. First, colors are sorted by their hue; Applicants use values to break ties between colors having identical hues.

FIG. 6 shows the 512 colors (i.e., the quantization color procedure of 9-bit RGB) obtained after quantization and sorting. The rationale for applying color quantization is that the feature set obtained from straight RGB values would be quite large, a total of 256^{(3*5)} cases for 5 color features. A feature set of this size would be mostly unnecessary as most colors are perceptually indistinguishable from neighboring colors with R, G, and B values differing only by few units from the original color. Thus, Applicants chose to cluster colors in such a way that colors with a given cluster are perceptually similar to each other. Next, Applicants investigated the size of each cluster. Larger clusters would lead to smaller features sets; however, larger clusters may also lead to the inclusion of substantially different colors in the same cluster. For this reason, Applicants studied empirically clusters of various sizes and concluded that clusters grouping 512 colors in each cluster, with 5-bit RGB values per cluster, gave them the highest accuracy results.

Applicants observed empirically that quantization and sorting are beneficial to the accuracy of gender predictions. In general, accuracy has improved by up to 15% because of these procedures. FIG. 5 shows in 3 dimensions the profile background colors distribution for male and female users, the quantization color centroid and background color distribution for both genders in the data set after applying the quantization color procedure of 9-bit RGB. In brief, the quantization color procedure is a reduction from 24-bit to both 12-bit and 9-bit RGB color representations. Applicants tried both finer and coarser representations for colors and found that 3 bits per color give the best prediction accuracy among the options that were considered. Applicants concluded that this representation was a reasonable compromise between the number of colors (i.e., the feature values) that one must consider and the perceptual differences within the resulting color clusters. Color quantization is especially important because Applicants used a total of 5 color features for each user analyzed. In general, quantization reduces the number of cases (i.e. combinations) for five color-based features from 256^{(3*5} cases to 32^{(3*5)} cases.

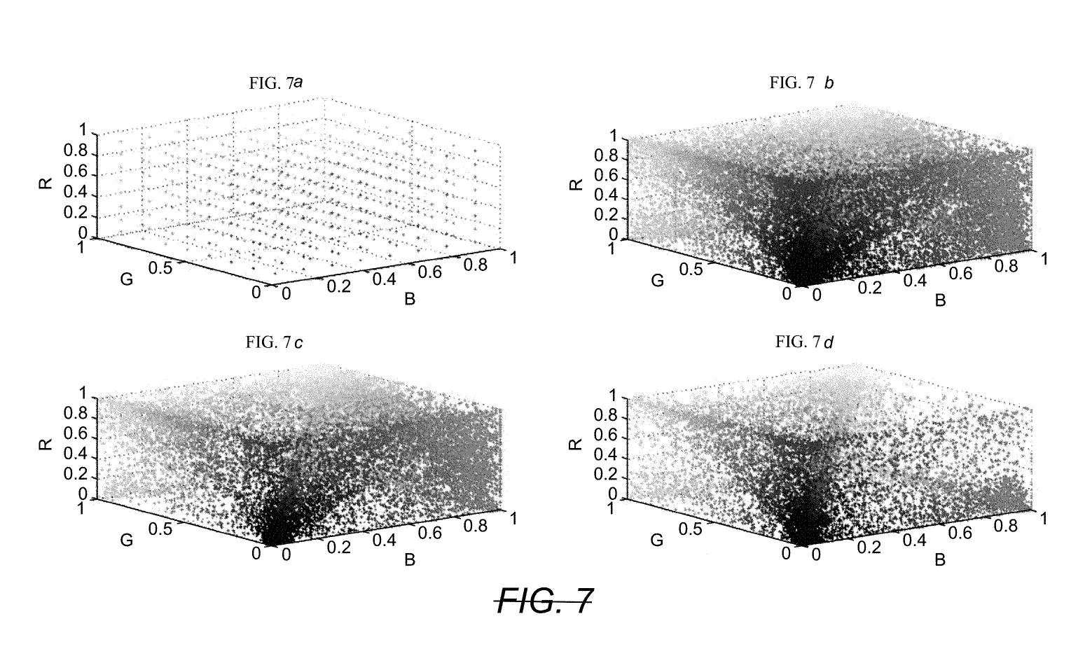

FIG. 7a shows the centroid of the quantization color procedure; FIG. 7 b shows the color distribution of both genders for the profile background after applying the quantization color procedure to the data set; FIG. 7 c shows the color distribution of the profile background of female users after applying the quantization color procedure to the data set; and FIG. 7 d shows a similar color distribution for male users.

Experimental Results: Applicants performed experiments, one for each of the four subsets of their dataset. In each experiment set, Applicants tried many classifiers; different classifiers produced different results. Next, Applicants selected the top classifiers. Here Applicants consider the following four different classifiers: Probabilistic Neural Network (PNN), Decision Tree (DT), Naive Bayes (NB) and Naive Bayes/Decision-Tree Hybrid (NB-Tree). Applicants performed a 10-fold cross validation on their data subsets for each classifier. In each set of experiments, Applicants trained their classifiers with all five color-based features.

An advantage of the present approach is that uses only five colors, making it language independent. An additional advantage is that it has a low-dimensional space, resulting in a low computational complexity of the classifiers. In contrast with the present method, most existing approaches are language dependent while using high dimensional spaces generated from unique words extracted from text (i.e. tweets, names, and profile descriptions), and millions of features.

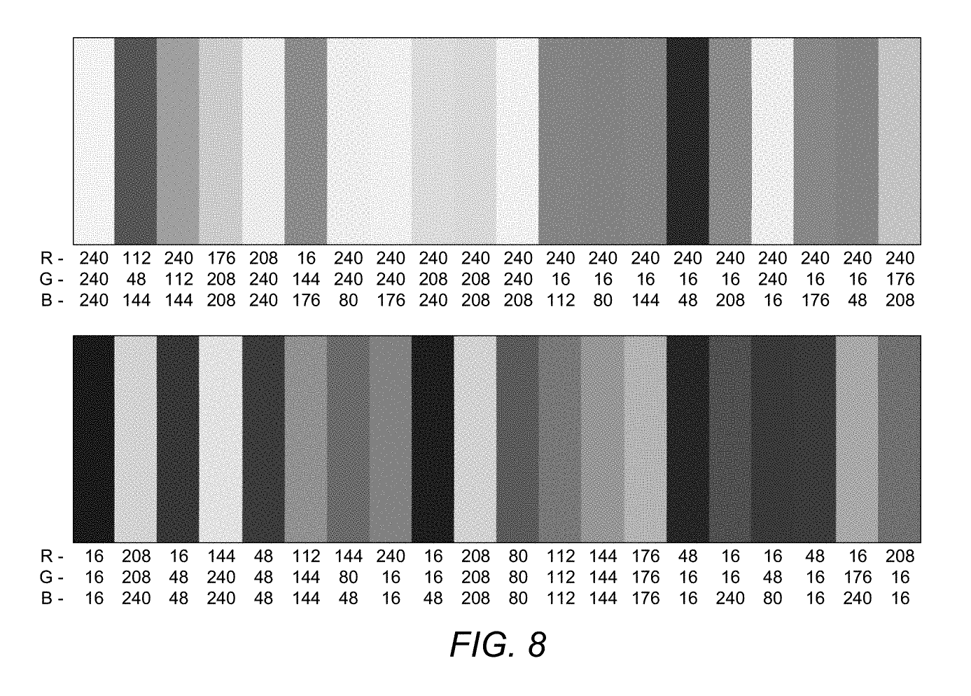

FIG. 8 shows the difference in colors chosen by female vs. male Twitter users. On the top there is shown popular colors chosen by female users (after clustering); the colors for male users are shown on the bottom of the figure.

Conclusion: Applicants have predicted automatically the gender value of users based on their color preferences. Unlike text-based approaches, Applicants used a novel method for predicting gender using five color-based features. Preliminary results with the collected data set are quite encouraging. Although there were considered only five color-based features, it was possible to predict gender with an accuracy of 74.2%, a gain of about 24% with respect to a 50% baseline. A key to this success of the gender guessing with colors is the preprocessing of color features using a quantization technique that was discussed above. An advantage of the present method is its broad applicability to Twitter users regardless of their language, as one uses only color-based features to identify gender. In addition, the color-based analysis shows promising results in term of computational complexity compared to other gender-guessing methods, which use a much larger feature set. The present approach may utilize only five color-based features. The results show that colors alone may provide reasonably accurate gender predictions, even though a substantial number of users analyzed do not change the default colors provided by Twitter in their Twitter profiles or in other web sites hosting their profiles (e.g., Twitter App). One may conclude that colors are a good gender indicator for users who do change the default colors in their profiles. In these cases, one is able to use colors alone as part of gender classification methods.

In this description, Applicant detailed their experimental study of gender classification on Twitter. Applicants presented a novel approach for predicting gender utilizing only five color-based features extracted from the profile layout colors. Unlike existing works that use millions of features, Applicants used only five color-based features. Despite the challenging feature-based characteristics for gender classification, it has been proposed color-based model for gender classification. There was applied quantization colors procedure to the color-based features that compressed the color from 24-bits to 9-bits and produced discrete set of 512 colors. Applicants empirically proved the validity of their approach by examining different classifiers over large Twitter data set collection. The present approach uses an agent with advanced colors preferences to search all profiles and predicting gender. The empirical studies show that the present method is reasonably accurate and highly efficient in terms of computational complexity.

Although the present embodiments have been described with reference to specific example embodiments, it will be evident that various modifications and changes may be made to these embodiments without departing from the broader spirit and scope of the various embodiments. Accordingly, the specification and drawings are to be regarded in an illustrative rather than a restrictive sense.

What is claimed is:

1. A computer-implemented method comprising:
receiving a color data set of a given user of an online social network, said online social network allowing said given user to select a set of colors within its profile; and
comparing said color data set of said given user to predetermined color data sets for determining a gender of said given user.

2. A computer-implemented method comprising:
receiving color data sets of a plurality of users of an online social network, said online social network allowing each user to select a set of colors within their profile;
quantizing said color data sets into predetermined color data sets;
assigning a gender to each predetermined color data sets;
receiving a color data set of a given user of said online social network; and
comparing said color data set of said given user to said predetermined color data sets for determining a gender of said given user.

3. A system comprising:
a memory; and
one or more processors coupled to the memory, wherein the memory comprises program instructions to:
receive color data sets of a plurality of users of an online social network, said online social network allowing each user to select a set of colors within their profile;
quantize said color data sets into predetermined color data sets;
assign a gender to each predetermined color data sets;
receive a color data set of a given user of said online social network; and
compare said color data set of said given user to said predetermined color data sets for determining a gender of said given user.
